(19) United States
(12) Patent Application Publication
(10) Pub. No.: US 2017/0098038 A1
(43) Pub. Date: Apr. 6, 2017

(54) GENOME-BASED DRUG MANAGEMENT SYSTEMS

(71) Applicant: Pathway Genomics Corporation, San Diego, CA (US)

(72) Inventors: James Plante, La Jolla, CA (US); David Becker, San Diego, CA (US)

(21) Appl. No.: 15/169,542

(22) Filed: May 31, 2016

Related U.S. Application Data
(63) Continuation of application No. 12/387,783, filed on May 7, 2009, now abandoned.

(51) Int. Cl. G06F 19/00; G06F 19/28

(52) U.S. Cl. CPC G06F 19/322; G06F 19/28; G06F 19/3456

(57) ABSTRACT

A drug management system based upon membership genomic data is coupled to cooperating external computing systems via an object server which prepares drug use reports for automated delivery in response to results that data output from the member database. Based on rules stored in a rules library a query engine runs tests on the stored member genetic information to identify and meet specified criteria.

### BACKGROUND OF THE INVENTION

### Field

The following invention disclosure is generally concerned with automated genome-based systems for management of drug use and specifically concerned with execution of computer implemented rules against stored genomic information for controlling drug development, application and use.

Recently one patient had been taking the drug Tamoxifen® for more than two years in hopes of preventing a recurrence of breast cancer. Then a new test suggested that because of her genetic makeup, the drug was not doing her any good. This test was performed manually on recommendation from her very alert and highly up-to-date doctor—not typically found in the common case.

The patient reported she was devastated and stopped taking the drug and initiated evaluation of alternative treatments. She had been taking the drug for all that time—only to learn later there were no effects at all.

This situation is all too common—and not just among the hundreds of thousands of women in this country taking Tamoxifen®. Merely because a typical doctor is unaware of a drug's relationship to any particular genetic make-up, and further that a typical patient treatment plan does not include careful consideration of the patient's genome, drug's are used unnecessarily at great expense while providing no benefit whatever.

Some experts might say that many drugs, whatever the disease, work for only about half the people who take them. Not only is much of the nation's approximately $300 billion annual drug spending wasted, but countless patients are being exposed unnecessarily to side effects. Accordingly, much hope is riding on the promise of “personalized medicine,” in which genetic screening and other tests give doctors more evidence for tailoring treatments to patients with respect to their own genetic composition, potentially improving care and saving money. However, this concept of care in not within the reach of the ordinary patient nor even most advanced treatments available. In only exceptional cases do patients and their doctors manually order genetic testing and even those results are only use to the extent the doctor has acquired special knowledge related to the relationship between the drug and genetic anomalies. Prior to the teaching herefollowing, there has been no automated system which compares drug use in view of a personal genome.

Many policy experts are calling for more studies to compare the effectiveness of different treatments. One drawback is that such studies tend to be “one size fits all,” with the winning treatment recommended for everybody. Personalized medicine including consideration of the patient's genome would go beyond that by determining which drug is best for that particular genetic make-up, rather than continuing to treat everyone the same in hopes of benefiting the ‘average patient’.

The colon cancer drugs Erbitux and Vectibix, for instance, do not work for the 40 percent of patients whose tumors have a particular genetic mutation. The U.S. Food and Drug Administration FDA recently held a meeting to discuss whether patients should be tested to narrow use of the drugs, which cost $8,000 to $10,000 a month. This step, even if adopted and recommended as policy by the FDA would still be executed manually by physicians—all but assuring a low adoption rate. The required time for patient-doctor interaction to bring about such practice in a treatment plan is significant and the doctor case load is not amenable to such interaction. A doctor must give the best plan which can be dispensed in 15 minutes or less and move on to the next patient.

An automated system for considering an individual's genome might help doctors determine the optimal dose of drugs such as Warfarin®, a blood thinner used by millions of Americans. Tens of thousands of them are hospitalized each year because of internal bleeding from an overdose or a blood clot from an inadequate dose. Presently, a doctor does not allocate enough time to check for a readily identifiable genetic marker which suggests that use of Warfarin® is too dangerous. As a result, patients are dying due to lack of an automated system which can take this step without further taxing a doctor's time.

Tamoxifen illustrates promise and current limitations of manual genetic testing. In 2003, more than 25 years after tamoxifen was introduced, researchers at Indiana University School of Medicine figured out that the body coverts tamoxifen into another substance called endoxifen. It is endoxifen that actually exerts the cancer-fighting effect. The conversion is done by an enzyme in the body called CYP2D6, or 2D6 for short. But variations in people's 2D6 genes mean the enzymes have different levels of activity. Up to 7 percent of people, depending on their ethnic group, have an inactive enzyme, while another 20 to 40 percent have an only modestly active enzyme. The implications are severe. Many women were apparently not being protected against cancer's return because they could not convert tamoxifen to endoxifen. However, with an automated genome-based drug use system enabled with carefully developed algorithms to account for these interdependencies and multiple dependant genetic variations, one can greatly improve application of drug use while simultaneously reducing expense.

Tamoxifen, now a generic drug, costs as little as $500 for the typical five-year treatment. But most patients in the United States are currently treated with a newer, much more expensive class of drugs, called aromatase inhibitors, that cost about $18,000 over five years. Those drugs performed better than tamoxifen in clinical trials before the role of 2D6 was generally understood. If only women with active 2D6 had been assessed, tamoxifen might have worked as well or better than the newer drugs. But as it was overly cumbersome for doctors to manage such application of the drug in view of each patient's genomic data, we only have information as to the effectiveness of Tamoxifen with regard to the general public without consideration of genetic variation.

### SUMMARY OF THE INVENTION

Comes now, James Plante and David Becker with inventions of genome-based drug management systems including devices and methods of applying prescribed stored logic against member genome data to control drug development, application, prescription, management, and control. It is a primary function of these systems to provide a drug management system having automated decision making based upon a personal genome. It is a contrast to prior art methods and devices that systems first presented here do not rely upon a highly generalized guess when considering the application of a drug therapy. A fundamental difference between automated drug management of the instant invention and those of the art can be found when considering its dependence upon an individual's personal genome. Thus drug management of these systems is highly personal and particularly crafted for the individual in view of ones genetic make-up.

### Objectives of the Invention

It is a primary object of this invention to provide automated drug management systems dependent upon personal genomes.

It is also an object to provide drug management via an enrollment/membership scheme where a personal genome is stored and forms basis for drug use decisions.

It is a further object to provide an automated system which couples with physician's office, pharmacy and drug manufacturers systems to improve management of drugs in their use and development.

A better understanding can be had with reference to detailed description of preferred embodiments and with reference to appended drawings. Embodiments presented are particular ways to realize these inventions and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURE

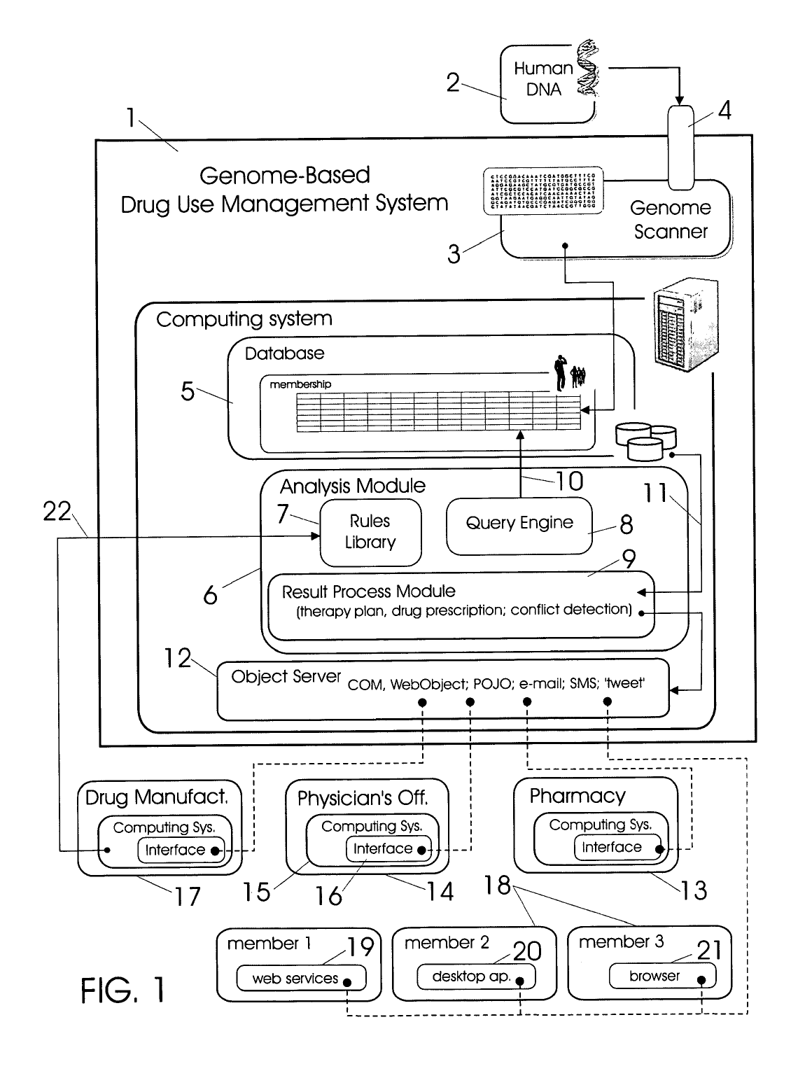

These and other features, aspects, and advantages of the present invention will become better understood with regard to the following description, appended claims and drawings where FIG. 1 is a generalized block diagram of one example version of system in accordance with these teachings.

### GLOSSARY OF SPECIAL TERMS

Throughout this disclosure, reference is made to some terms which may or may not be exactly defined in popular dictionaries as they are defined here. To provide a more precise disclosure, the following term definitions are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must consider context of use and provide liberal discretion to arrive at an intended meaning. One will be well advised to error on the side of attaching broader meanings to terms used in order to fully appreciate the entire depth of the teaching and to understand all intended variations. ‘personal genome’

A ‘personal genome’ is an expression, either complete or a portion thereof, of a any particular person's DNA.

### PREFERRED EMBODIMENTS OF THESE INVENTIONS

With reference to the drawing figures and in particular FIG. 1 which is a general block diagram of one example version of these genome based drug use management systems 1. The general public may participate as system members by voluntarily submitting a DNA sample 2 for processing at a genome scanner 3. DNA is received at a receiving port 4 where it is subject to chemical and electro-optical processes to read genetic sequence features of the DNA including genes, alleles, polymorphisms, “copy number” instances, et cetera. The output of the genome scanner is a digital representation of a person's genome. While in some cases this may not be a complete genome sequence, modern systems are configured to readily read 10 million features in a single inexpensive process and therefore a system member may have her genome expressed by millions of genome subset sequences.

The output of the genome scanner is carefully coupled to a membership database 5. A database is prepared with a structure and architecture which supports storing a great plurality of unique member genomes and means for identifying those with respect to a member to whom they belong. Accordingly, database schema are prepared to enforce a one-to-one relationship between a member and a digital representation of a genome received from the genome scanner by way of a unique identifier index. In addition, the database may further store data related to a member such as contact and address information, medical history; lifestyle classifications, family history, et cetera. In some versions, most important address information includes an e-mail address which enables special functionality disclosed hereafter. It should be appreciated however that in all cases the membership database structure is arranged to firmly couple a single genome to a single member and maintain an association therebetween. In this manner, drug use functionality described herein is directed to the appropriate persons.

With a database so prepared as described above, an analysis module 6 of these genome based drug use management systems also coupled to the membership database. An analysis module comprising primarily of a rules library 7 and a query engine 8, and a result processor 9, forms the essential backbone of the system.

The rules library accommodates stored logic which forms rules and analysis algorithms related to drug therapies and other drug use programs and issues. These rules and analysis algorithms may be prepared in advance view of system objectives and further may be subject to updates and frequent tuning. They may be updated and adjusted from time-to-time and the library is suitable for accommodating additional rules as they might be developed in view of new research. Rules may be formed such that they are dependent upon genetic features which may be found in a human genome. In a most simple example a rule might be formed to consider the presence of a particular single nucleotide polymorphism (SNP) in a genome. As a drug use program may depend upon indicators found in a person's genome, the presence or absence of a certain known SNP may be used to modify a drug use therapy. More advanced compound rules may depend upon several distinct features of a genome. For example, a particular rule may be configured to perform a Boolean logic operation on two or more features of a digital genome representation to find the presence of a particular SNP and its copy number (number of instances). Various rules can be written and embodied as stored code in a rules library to accommodate infinite possibilities of features which may be found in a genome. In some special versions where a member's family history and medical records are maintained as part of a member record, a compound rule may be additionally devised to depend upon those data as well. In this case, a database schema includes structure to accommodate discrete family history data and discrete lifestyle data for example, in a fashion whereby it may be sorted, indexed, and searched electronically. Rule written against this data are in further view of genetic data drive additional drug use plans. Therefore, it is entirely possible to prescribe a rule to search member records and identify all those who: 1) “had a heart attack” (medical record); AND 2) “are an active smoker” (lifestyle); AND 3) “have a SNP associated with heart disease”. Such a rule may be written in computer code and stored as a function in the rules library.

Rules stored in the rules library form the basis upon which a query engine may interrogate the member's database. The query engine manages formation of computer executable queries 10 in agreement with a database procedure and function such that these queries may be run periodically against data stored in the database to produce results output 11. Results output may include subsets of data stored in the membership database. For example, a rule devised to select all members having genetic predisposition to Celiac disease may form basis for a SQL ‘select’ query such as:

“SELECT*[members] WHERE [HLADQ2] OR [HLADQ8]=TRUE” ‘HLADQ2’ and ‘HLADQ8’ being the genetic markers for Celiac disease, i.e. the genetic markers for Celiac disease are present and those numbers are at risk of developing complications due to Celiac disease. The query engine may run the query against the membership database to identify members having a predisposition to the disease. A query may be run once, run periodically on a recurring schedule or be programmed to run on demand.

In addition, the query engine supports special events such as a ‘new member’ event. When a new member joins, it is useful to run an entire collection of queries on that new member genome. Accordingly, the query engine is arranged to run specialized query sets in response to a new member being added to the database.

As a response to a query being executed, a result set is produced and conveyed to a result process module. The results set is comprised of all the “hits” or members having data in agreement with the particular rule being tested. The result process module produces a response appropriate for circumstances defined in the rule—and it may do this specifically for each member found to have the genetic characteristic defined in the rule; and the response may be different for each in view of particulars stored as a user profile.

In one first illustrative example, the result process module may produce a therapy plan e.g. for persons having a genome which suggests predisposition to a particular disease.

In consideration of artifacts found in a member's genetic profile a drug use prescription or therapy plan may be provided. This may include combinations of drugs which might better serve the particular features of the genetic profile in question. A drug therapy plan output of these systems may be transmitted to a physician's office for further review and consideration in view of the normal course of a physician's practice.

A result process module may receive a result set response from execution of a query to receive a group of members who would benefit from a specific drug prescription. For example, those members genomes which suggest Alzheimer's disease might benefit where the result processor provides a therapy plan for earliest stage Alzheimer's disease mitigation including use of Cholinesterase inhibitor drugs: donepezil (Aricept), galantamine (Razadyne) or rivastigmine (Exelone).

In this example, a report may be provided with names and addresses of persons having an increased predisposition to some disease without yet showing any symptoms. The report can be passed to a marketing services company who might provide educational materials and care suggestions for those of most likely to later need this information. While it is not efficient to send Alzheimer's disease management information to the general public, it is far more effective to provide such materials to those having a genetic predisposition to the disease. In some versions, a report output in response to identifying members of a group who might benefit from a drug may be sent to a drug manufacturer so that they may better configure the drug packaging, marketing, and advertising campaigns they might use to promote use of the drug.

Further, a result process module may receive a result set and prepare a reference report of studies collections of studies and drug use statistical date for example for a member's review.

Members interested in further education about drugs they currently use may receive reports which might be newly updated from time-to-time in accordance with this version of the invention. Accordingly, after execution of a query on the member's database, an object server may provide a package of research studies to those to whom the information is most relevant.

An object server is arranged to prepare and deliver various types of electronic communications ‘objects’ which carry a payload of genetic information while additionally including the overhead of a cooperating target machine or computing system. For example, an object server may prepare a response as a ‘COM object’ which might be consumed on a desktop application for example a Windows operating system based application. Alternatively, a ‘WebObject’ might be arranged as an XML package consumable on a general-purpose Web browser system. In addition, some versions of these systems may embody drug use reports and information as POJO or “plain old Java objects” which interface with and are readily consumed by Java-enabled computer systems. In still other versions, a report may be wrapped in an ‘e-mail’ overhead and transmitted to an e-mail client e.g. ‘Outlook’ of an interested party. In some special versions, drug use output reports may be configured by the object server as an SMS message and routed by telephone number to an intended recipient. An object server may be arranged to deliver drug use information via 140 character ‘tweet’ messages compatible with the Twitter platform and paradigm. In further important versions, an object server may prepare drug use information as a Flash type computer file including high functionality ActionScript to be run on a FlashPlayer enabled computing platform. In this way, an object server is well coupled via various forms of electronics medications to many recipient targets.

An object server 12 is provided as part of the original computing system to receive information, for example a therapy plan; a drug prescription; or drug conflict definition; etc., from the result processor and configure the information using an OOP model as an “object” and presenting the State thereof in accordance with the output of the result processor. The object server then transmits the object to a cooperating computing system for example those which may be deployed in a pharmacy 13, physician's office 14, drug manufacturers research laboratories 15, where the object may be consumed in a manner to advance a drug use strategy. In this way, these automated drug use systems are suitable for communication and interface with various computing platforms and purposes.

In one most important example introduced above, a pharmacy equipped with a highly advanced drug conflict system further benefits from receipt of information as it relates to particular patient's genome. That is, today pharmacies deploy automated computer systems to check a particular patient's drug use and determine if simultaneous use of two separate drugs present any conflicts. However these systems and do nothing to consider a patient's genetic composition when performing a drug conflict check. In view of the systems taught here, an enabled pharmacy would request information on a certain patient and received a drug use conflict report based upon genetic information without receiving the patient's highly confidential genome data. The result processor developed a drug conflict definition and that is passed by the object server to proprietary software running on pharmacy computers.

Similarly, in a second most important example, these systems may be coupled to software used by physicians in the positions office 14. A computing system 15 prepared with a priori knowledge of a certain interface 16 is well coupled to receive from the object server a therapy plan object. Independent software at a doctor's private office then uses the object which is based upon, but may not include a complete genetic disclosure. Physicians running appropriate computing software can be advised of drug therapy plans devised in view of the patient's genome—freeing the doctor from becoming a drug geneticist while having continuous access to updates by way of the ever-changing rules library.

In a third most important example, drug manufacturers can receive drug performance data compiled in view of common features present in drug users genome. Drug performance studies can more precisely target problems, issues, unexpected benefits, etc. when they include computing systems prepared with an interface to receive information by an object server specifically designed to provide genetics related drug performance data to drug manufacturers. Further, drug manufacturers are in a position to provide feedback 22 which might be used to further adjust and tune the rules library. Either new rules or modifications to existing rules improve the overall system as future queries will produce a more accurate result sets when based upon improved definitions in the rules library.

Still further, drug manufacturers can receive a special object configured as a “society” of persons carrying an important genetic feature or anomaly. A society of persons in the same genetic class might be ideal for directing marketing campaigns to more accurately inform people of the existence of drugs which could benefit them. A society object may be comprised of a list of potential drug beneficiaries and their appropriate contact information so that drug marketing campaigns can be devised to most effectively address these persons with the prescribed genetic feature.

In accordance with each of preferred embodiments of these inventions, genetics based drug management are provided. It will be appreciated that each of the embodiments described include an apparatus and that the apparatus of one preferred embodiment may be different than the apparatus of another embodiment. Accordingly, limitations read in one example should not be carried forward and implicitly assumed to be part of an alternative example.

The examples above are directed to specific embodiments which illustrate preferred versions of devices and methods of these inventions. In the interests of completeness, a more general description of devices and the elements of which they are comprised as well as methods and the steps of which they are comprised is presented herefollowing.

One will now fully appreciate how automated drug use management systems dependent upon stored personal genomic data may be realized. Although the present inventions have been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

What is claimed is:

1) Human genome-based drug use management systems comprising:
a genome scanner;
a membership database;
an analysis module; and
an object server,
said genome scanner is coupled to a membership database whereby a digitized representation of a person's genome is associated via an identity index with a system member, the genome scanner further having a receiving port arranged to receive human DNA therein,
said membership database is configured with database schema to enforce a one-to-one relationship between members via a unique identifier index and genomes stored therein, the membership database being further coupled to a query engine of said analysis module,
said analysis module is comprised of a rules library, the query engine, and a result processor with an output coupled to the object server,
said object server is coupled to at least one remote computing system via a prescribed object interface.

2) A human genome-based drug use management system of claim 1, said genome
scanner arranged to receive human DNA and isolate and detect the presence of prescribed genetic sequences and to provide as output to a membership database a digital representation of at least a portion of a human genome associated with the received DNA.
